(19) United States
(12) Patent Application Publication
(10) Pub. No.: US 2014/0368627 A1
(43) Pub. Date: Dec. 18, 2014

(54) SYSTEM FOR DISPLAY OF VISUAL MATERIAL TO THE VISUALLY IMPAIRED

(71) Applicant: AbleCon AS, Asgardstrand (NO)

(72) Inventors: Arnfinn Kalvenes, Asgardstrand (NO); Egil Edwin, Holmestrand (NO)

(21) Appl. No.: 14/370,569

(22) PCT Filed: Feb. 22, 2013
(86) PCT No.: PCT/NO2013/050035

§ 371 Date: Jul. 3, 2014

(30) Foreign Application Priority Data
Feb. 27, 2012 (NO) 20120207

(51) Int. Cl. H04N 5/232; G02B 27/02

(52) U.S. Cl. CPC H04N 5/23229; G02B 27/027
USPC 348/63

(57) ABSTRACT

The invention relates to a system for the display of a visual material, in particular an aid system for the visually impaired, comprising a camera to depict the visual material and a screen for controlled display of the material. The system also comprises a control unit, comprised of a user interface set up to communicate one or more commands to the system, where the commands include indication of at least one unique position for the visual material, and a communication part to communicate instructions to a camera, said instructions comprise given positions for the visual material, and where the camera comprises a control part that controls the camera to provide an image of the chosen visual material at the given positions.

To be visually impaired can relatively easily be expressed in quantitative forms which relate to seeing more or less. For example, one can imagine that what a person with normal eyesight sees at a given distance, a visually impaired person must come considerably nearer to see clearly. This is a very simplified way of imagining impaired vision. There are many types of visual handicaps that bring a person into the category of the visually impaired. For example, Macula Degeneration, which gradually removes central vision parts (the sharp sightedness), here one will have a need for and pedagogically use, a camera for enlargement, so that the text becomes readable in peripheral vision areas. Another common visual problem is Retinus Pigmentosa which is rather opposite to the above where peripheral vision areas disappear first. Here, one can also get some help by a degree of enlargement, but if it gets too large the text pulls out of the field of visual. Here, it can often be that the text is bright and can be manipulated with respect to contrast and colour be just as important as size. In addition, there are other visual diagnoses that give partial loss of visual field and light sensitivity and so on. Here, to be able to invert the colours so that the eye does not receive so much white light (blue frequency), will be a useful functionality. What one sees is that impaired vision is, to the fullest extent, a qualitative reduction of a function. Therefore, the present invention is, in particular, directed towards the visually impaired who cannot be helped by glasses or lenses and who are placed in the group visually impaired and very visually impaired with regards to the WHO classification of 1973 (WHO-ICD 10).

The traditional CCTV that uses a video camera and a screen has, over time, developed into having some standard functionality such as, for example, manipulation of size, light, contrast, colour, inversion and so on.

Traditional solutions can simply be described as a close-up camera that films reading material which is placed underneath, where the image can be manipulated with respect to size, contrast, colour and so on. This image is projected via a cable to the pc of the pupil and is manipulated via a control panel. This can also be supplied with a distant camera that is combined with the PC in the same way, via cables (CCMV). This gives limitations relating to the positioning of the pupil in the classroom with respect to the electricity supply, location/ergonomics and also that the equipment is stigmatising for the pupil and even portable solutions involve some connecting and disconnecting.

Another example of prior art is given in the German patent application nr. DE 10 2010 015 977 A1. This shows a teaching orientated system that shall give everyone the possibilities to follow the teacher and what he is doing in a classroom. The teacher, blackboard or the like is caught by the system and the system allows a number of terminals to view this. The aim is initially that one shall be able to see even if one has an unfortunate location and is controlled with regard to several users without any consideration being given to the particular needs of an individual. The individuals are given a possibility to magnify the screen image, but only via local magnification on the machine. This is because several terminals share the same image and a local magnification will not influence the display of the image on other terminals. A such magnification will gradually, as one increases the magnification several times, meet its limitations in the resolution of the image. With increasing magnification one will get smaller and smaller parts of the display presented on the screen of a more and more grainy image lacking clarity. This means that one must navigate around the image to a large extent to catch the total picture, and also that lack of clarity and missing magnification level limit to what extent the visually impaired can make use of this system. The visually impaired are not given an opportunity themselves to control what is shown on the screen.

According to the present invention a high-resolution HD camera is used that combines a zoom function in the camera and is possibly supplied with a local software magnification on the machine. The local magnification in the camera comprises optical magnification with a supplying digital magnification where the optical magnification stops. As mentioned, this can, in addition, be supplied with a local software magnification on the machine. The essence of our invention is that the visually impaired also have full control over the local magnification in the camera and also full navigational possibilities over 360 degrees in the horizontal axis and up to 180 degrees in the vertical axis. In addition, it is important that the visually impaired can manipulate images with the functions in the camera that offer the possibility of inversion of colours and so on.

One of the aims of our invention is thereby to liberate the pupil so that the pupil can achieve optimal locations in the classroom. It is also an aim to be able to reduce the amount of equipment on the individual workplace so that the pupil can sit at standard school desks in a less segregating environment and is ensured good ergonomics, at the same time as the information on the pupil's screen is optimised according to the need of the pupil. It has also been a goal that the pupil has the least possible equipment that shall be connected and disconnected.

This is achieved with a system as described in the enclosed claims.

The camera is preferably wirelessly connected with the rest of the system to give maximum freedom for the pupil to choose his position in the room. According to the invention a camera is required that has sufficient resolution and possibilities for magnification to satisfy the requirements for working close-up and working on the blackboard. This will be achieved by a combination of optical magnification and digital magnification. The ratio between these will then be given by the resolution of the chip and the camera's objective. Using a powerful, wireless router connected to the camera the student can log on via the IP address of the camera. With the help of adaptions such as efficient storage of image position and magnification, efficient storage of images on the machine, efficient manipulation of light and contrast level, swapping between positive and negative images or colour levels, and effective control of the camera, this can be used effectively in, for example, a classroom. The most important of all has been that it shall be possible to perform this from the keyboard or corresponding aids on the pc of the pupil.

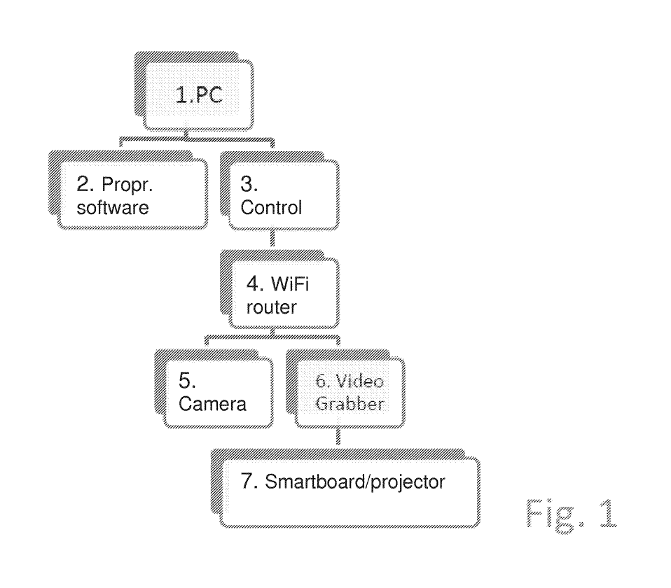

The invention will be described below with reference to the enclosed drawing, which illustrates the invention with the help of an example as given in FIG. 1.

FIG. 1 shows schematically a possible set-up of the system according to the invention, where the user applies a computer 1. This is connected to a dedicated software module 2 and a controller 3 set up to control the system based on signals from the computer, based on messages from the user via a user interface.

According to the preferred embodiment of the invention, the control signals from the control 3 are sent on via a wireless router 4 to a camera 5. This camera is set up to be able to be directed towards a position in the room which the user, via the user interface, indicates on his computer. The camera will preferably have sufficient resolution and magnification to be able to depict text or pictures in the chosen position. In practice, this can result in a camera with a minimum HD resolution (HDTV 720p, with 1280×720 pixels and 18× optical zoom and 12× digital zoom). The image that is taken by the camera 4 is sent via the router to the computer 1 to be shown to the user. Furthermore, according to a preferred embodiment, the system can be able to convert elements in the image signal from the camera, for example, with the help of OCR, to a text that can be edited and be further processed by the user or can be converted to speech via a suitable program and stored as a sound file.

The router 4 can, in addition, be connected to a video source 7 via a video grabber 6 to collect image signals from this to display directly on the computer screen of the users. Here, text can also be converted from image information to text that can be edited. In this way the user can show text on the desk, or other locations in the room, on the computer screen, and the video signal that the teacher or lecturer shows on the screen for the whole class. All the collected signals from the camera and the video grabber can be edited and adapted to the need of the user. An additional camera can be connected to the system for mobile use on moving between several classrooms.

The individual components shown in the drawing will be described in more detail below.

### Description of the Tasks for The Individual Parts of the System

### Reading of the Camera

Reading of the camera close-up and board distance. The PC looks for a wireless router and provides the network of the camera. A suitable software sends on the control of the camera and the manipulation of the image to a wireless router which in turn sends it on to the camera. The camera carries out the required task and sends the image via the network cable to the router which transfers this wirelessly to the network card on the PC and then back to the software that shows it to the user. Two-way communication between the PC, software, router and camera. The software could be a combination of dedicated communication protocols, as adaption of keys and commands on the computer to the operations in the camera, and standardised communication protocols for use in networks and other signal transmissions.

The software, manipulations and the controls of the image that are installed onto the keyboard commands (speed keys) make it possible that a camera that is built for monitoring can function as a pedagogic aid for the visually impaired.

It will be possible to carry out the control of the camera manually with the help of, for example, arrow keys to a desired position or in that individual positions are defined in a coordinate system in the room, so that an indicated position is translated by the controller to coordinates which, in the control system of the camera, indicate where the camera platform shall be directed and possibly which magnification/focal length shall be chosen to give a image of the wanted area.

These coordinates can be fed in manually, be chosen after one has steered the camera to the position and stored this, or that one uses/has a marker and the control system comprises a search system to find and store the position of the marker. Stored positions are stored in the camera.

### Grabbing

The PC sends a message via the wireless router to the video grabber. The video grabber snaps the picture that is in one-way communication from the smart board/projector to the video grabber via a VGA/DVI/HDMI cable. The video grabber sends this picture through the network cable to the wireless router that sends this on wirelessly to a PC that opens this in a suitable software, possibly developed for this purpose. For example, it can be opened in the program VGA2Ethernet from Epiphan, but other solutions can also be imagined. This makes it possible that the picture which normally is shown on a projector is transmitted directly to the pc of the pupil and is manipulated and magnified here.

### OCR

A PC with suitable software sends a message via a wireless router to a camera that it shall provide an image. The image is sent via a wireless router back to the network card on the PC. The image is sent to the OCR module software that is stored and thereafter the OCR is processed by the OCR module set up to present the text as speech and which can store this in a suitable format, for example, as an mp3-format. The sound file is played with Media Player or other corresponding programs. This combination makes it possible that a camera that is built for monitoring can function as a reading tool for the visually impaired. These are functions that can be integrated in the dedicated software.

The following equipment is used as components to make a dedicated system with reference to FIG. 1:

1. PC: Standard portable PC with a powerful processor (dual core or Quad core, 1 GB memory on the graphics card, minimum 4 GB RAM, 500 MB hard disc). It must be pointed out that there are many other alternative possibilities here.

2. Dedicated software: Dedicated software that is stored on a platform for both Macintosh (OS X) and Microsoft Windows OS. Based on control via communication with a camera over the TCP/IP addresses and the protocols. Function commands that are programmed to the speed keys are: move the camera, light, contrast, start/stop of the image, inversion of the image, 9 pre-set positions and zoom level, zoom in and out. This makes it possible for quick and good control for the visually impaired. In addition, a module is built-in to change colours in the image and provide an image with the camera and store this directly to a separate image folder. Furthermore, there is support for OCR processing and reading of this image. The software can either be placed in its own server or be implemented in the computer. There is also support for connecting several cameras and a simple change between images from the actual camera. The control possibilities and the manipulation possibilities are alternately functional between the cameras.

3. Controller: The controller will give the positions the camera shall be set at, wanted magnification, etc.

4. Wireless router: Dlink Dir615, WAN 2.4-2.4835 GHz, IEEE802.1 b/g/n. Speed up to 300 Mbps. Four LAN ports and two wireless aerials. The system functions also on less powerful routers, but is then more sensitive for placing in relation to where the PC is placed. It is pointed out here that it is possible to use many other alternative wireless routers.

5. Camera: For example 50 Hz PTZ Dome Network Camera, HDTV 720 p with 1280×720 pixel resolution that delivers H.264 (optimises band width and storage over net without loss of picture quality). The camera that is used during testing gives 18× optical zoom and 12× digital zoom, and can rotate 360 degrees. Connected to its own electricity supply High Power over Ethernet (High PoE) IEEE 802.3 at, Max 30 W 20-24 V AC, Max 23.6 VA. 24-34 V DC, Max 17 W. Connections: RJ-45 for 10baseT-100base-TX PoE.

The camera that is used must have a high resolution to be able to carry out a good quality OCR processing. It is pointed out that here it is possible with many alternative cameras. For example, several solutions can be imagined with more cameras or one camera that can be fitted in other locations than in the ceiling and can be taken along into other rooms.

6. Video grabber: A wireless video grabber is connected with a network cable to a wireless router. It provides the images from the teacher via a projector and VGA/DVI cable to the video grabber that sends VGA images over the Ethernet cable in to the wireless router. The image is shown via the software of the grabber that shall be programmed into the dedicated software by listening to the gate and the protocol which the image is sent on. The video grabber that is used during the testing catches and sends VGA, DVI and HDMI video sources to the Ethernet, up to 60 pictures per second. With a wanted resolution of 1920×1080, it manages a speed of up to 30 pictures per second. The transmission from the video grabber takes place via RJ45 Gigabit Ethernet. Here it will be possible with many other alternative video grabbers.

7. Projectors: The rooms where the dedicated system is connected up often have a projector and this is often a bottleneck with regard to wanted resolution. The standard is 1024×768, but 1920×1080 in more modern versions. The projector shows the data image of the teacher on a large canvas, screen or smart board. A VGA splitter is connected to split the screen signal, or connected to the video out output of the projector to send this image further to the video grabber.

The functions in the dedicated software relating to manipulation of an image function as follows:

### Increase and Decrease Magnification.

The visually impaired pupil will have a different need for magnification depending on the viewing function and size of the teaching material. Consequently, it will be important that the pupil can, in the simplest way, adjust this himself. Primarily it has been chosen to put the control of all functionality to the keyboard for several reasons.

To provide close proximity of the control function through control without an external control panel. To make the equipment “invisible” to the other pupils so that the visually impaired pupil only requires his own pc placed at his workplace. This will make the equipment considerably less stigmatising, which unfortunately has been, in our experience, the reason why today's established systems are not used in adequate situations.

It is also important that the pupil does not have to “drive round” with a camera looking for wanted positions and magnification levels. Therefore, a possibility for storing of both parts is available, something which will be described in more detail in the theme storage of magnification and positions. These functions are given the following keyboard keys:
Increased magnification: Q
Reduced magnification: W

The keyboard keys Q and W are chosen with consideration that the youth of today use these keys during different computer games where you zoom in and out of the action.

### Change Position

It is important for the visually impaired to be able to read close up materials such as book, notes and also distant goals such as the blackboard, poster boards, clocks door exits, and so on. Consequently, this is also added to the control from the keyboard. This can also be stored in something which is described in more detail in the theme storage of magnification and positions. These functions are given to the following keyboard keys:
Move position to the right: Arrow right
Move position to the left: Arrow left
Move position up: Arrow up
Move position down: Arrow down

Traditional camera solutions will require that the pupil does not sit too near the blackboard as the angle deflection to the left and the right can quickly become too large. This is particularly relevant for camera systems where you move the angle manually. Thus, the dedicated system makes it possible to have a greater radius for placing the pupil in the classroom. Then, the camera standing behind the pupil and, inside a given radius, can still catch the close-up work of the pupil. One should also note that here there is no limitation with respect to the camera that can be in the way with, for example, the hand work.

### Storage of Magnification and Positions

To be able to move faster between much used positions with an adequate magnification level the possibilities of the camera are used maximally by storing both the position and magnification level. This gives the possibility of storing up to nine different positions/magnification levels, while established systems have three. These are also given to the keyboard for the reasons given above.

We have given the functionality in the number series 1-9 to store a picture point one first sets the angle and thereafter magnification level, when a picture is considered to be right for the user, it can easily be stored by holding down the ALT key at the same time pressing the number one wants for this picture point. For example:
Store picture point 1: ALT 1

It is important that the pupil can himself set these storage points in the simplest way possible as the different storage points can vary relatively often. It can vary from teacher to teacher where on the blackboard he exemplifies. One should also note that the pupil can move place by, for example, in group work, and the focus of close-up work must be altered.

The storing of position and magnification is stored in the memory of the camera and is activated from the dedicated software via the API of the camera.

### Go to a Picture Point

This function is also given to the keyboard. One brings up the stored picture points by pushing the number to which the picture point is associated. For example: Go to picture point 1: 1

Many visually impaired have a need to finely adjust the contrast level and brightness level. These are functions that are also given to the keyboard:

| | |
|---|---|
| Brighter picture | ALT S |
| Darker picture | ALT A |
| Increase contrast | ALT Z |
| Decrease contrast | ALT X |

In this case, there is no installed storage of the level, as this can be settings which, for many reasons, for example, ambient brightness, the surface of the sheet of paper and so on. One can quickly reset back to the starting position by pressing the letter R (for reset).

| | |
|---|---|
| Reset picture | R |

### Set to Black and White Picture

To obtain the contrast between black and white on everything that is read, the possibility to operate a black/white function is installed in the camera.

This is installed in the keyboard under the letter B. Repeated pressing changes between black/white picture and coloured picture.

| | |
|---|---|
| Black and white picture. | B |

### Inversion of Picture

Many visually impaired persons will experience improved visual acuity and/or endurance at the inversion of pictures. This is because the contrast level is maintained, but the amount of high frequency light is reduced considerably. Therefore, this function is installed in the keyboard in the letter i. Repeated pushing alternates between a positive and a negative picture. This function operates both in colour and black/white function. It will, as a rule, be most functional in the black/white function.
Inverting picture i

### Providing an Image

As many pupils will enjoy being able to provide images of, for example, a blackboard instead of having to take notes themselves, this is one of the functionalities of the camera that is installed in the keyboard. This is obtained by pressing Ctrl and S. The image is stored automatically with date and time as a name in the folder My pictures on the pc of the pupil. Here, one can set up a folder structure oneself that can make it more functional with regard to subject and point in time.

| | |
|---|---|
| Provide an image | CTRL S |

Most manipulation possibilities relating to pictures are, in a sense, common for other camera systems, but as an aid for the visually impaired the present system will distinguish itself by more storage possibilities for position and magnification. However, the present system is more than a CCTV and CCMV in the traditional sense. The present system will be able to make OCR of documents and read the text aloud.

### OCR

The PC sends a message from the dedicated software via a wireless router to the camera that it shall take a picture. The picture is sent via a wireless router back to the network card on the PC. The picture is sent to the OCR module in the dedicated software that is stored and thereafter the OCR is processed by the OCR module with a Norwegian voice that reads the text and stores it as a sound file, for example, in mp3 format. The sound file is played with a sound player program. This combination makes it possible that a camera, which is built for monitoring, functions as a reading tool for the visually impaired. There are CCTV systems with an OCR function today (came on the market late 2011), but the present invention makes whole-page OCR possible as a consequence of the distance to the reading material and the high resolution of the camera.

### Grabbing

We have previously delivered so-called grabbers (picture grabbers) to the visually impaired at schools. This is equipment that sends pictures from a projector to the pc of the pupil without disturbing the “normal” teaching activity on the screen/smart board. Here, the individual pupil is given a picture which is not that easily disturbed by the lighting conditions in the classroom and which can be manipulated by the pupil's own magnification program. Traditionally, this has taken place by running a cable from the projector and down to the grabber that is at the desk of the individual pupil. In the present wireless system there are also possibilities to include a wireless grabber.

This functions in the following way:

The PC sends a message via a wireless router to the video grabber. The video grabber snaps the picture that is in one-way communication from the smart board/projector to the video grabber via the VGA/DVI/HDMI cable. The video grabber sends this picture through the network cable to the wireless router that sends it on wirelessly to the PC which opens it in the dedicated software). In the test version this was opened in the video grabber software, but this can be integrated in the dedicated software. This makes it possible that the picture which normally is shown on projectors is transmitted to the PC screen of the user where it can be further manipulated with respect to size and so on.

### Several Cameras

The system can be supplied with several cameras that can be controlled via the same software. The software simply moves between the cameras with the speed keys F10, F11 and F12, where the functionality and possibilities for manipulation move between the cameras. This can be particularly relevant in the moving from one classroom to another. Additional cameras will only, in specific cases, be necessary within one and the same classroom, as a camera mounted in the ceiling covers all positions with a good magnification. This is, in particular, imagined as a mobile possibility in the moving between classrooms.

To sum up, the invention relates to a system for the display of visual material, in particular an aid system for the visually impaired, comprising a camera to provide an image of the visual material and a screen for controlled display of the material.

The system also comprises a control unit encompassing a user interface, set up to communicate one or more commands to the system, where the commands include an indication of at least one unique position for the visual material. The control unit can comprise a computer 1 with a suitable software 2 and a controller 3, with these elements integrated or as separate units. It also comprises a communication part 4 to communicate instructions to a camera 5, said instructions comprise given positions for the visual material, and where the camera comprises a control part that controls the camera to take a picture of the chosen visual material at the given position.

The control unit can include a register comprising a set of positions, and the user interface is set up to let the user choose one of the given positions. The positions in the register can, for example, be pre-defined in a coordinate system that represents the space, after markers that can be searched for or stored after control of the camera to a given position.

The camera in the system is preferably placed in the ceiling of a room comprising at least two registered positions, of which the one position is the workplace of the user and the other is at one of the walls of the room, preferably comprising a display screen or the like. In practice a preferred system will have cameras that can cover a large number of positions with good magnification. Normally of the order of 4-5 much used positions in the classroom, for example, the notice board, several positions on a standard school blackboard, the workplace of the pupil and the school clock. By the use of so-called smart board or active blackboard the information from these can also be brought in via the grabber function.

The control signals sent from the controller can include signals which indicate a wanted magnification of the visual material in a chosen position so that the camera can zoom in on the chosen areas.

The camera communicates preferably wirelessly with said communication part 4, but the cable network can also be considered used at the cost of the flexibility of the system.

The software of the system preferably comprises means for the conversion of at least the smallest parts of the visual material to text symbols or to be read by a voice generator.

The user interface will normally comprise a keyboard where given commands are associated with pre-determined keys, for example, function keys and arrow keys. The command comprises adjustment of the chosen positions, for example, with arrow keys, zooming and contrast and colour representation.

The camera is preferably mounted in the ceiling and covers a radius of 360 degrees in the horizontal axis and up to 180 degrees in the vertical axis, where the camera also comprises a zoom objective to adjust the magnification of the visual material in the chosen position. For use in teaching purposes the computer and camera are preferably placed in a teaching room, where at least one of the chosen positions is a workplace for a student and a second position is the position of the lecturer.

The system also comprises means for the transmission of image signals directly from the signal to a projector or the like.

1. System for display of a visual material to a user, the system comprising:
a camera to depict the visual material;
a screen for controlled display of the material;
a control unit comprising a user interface set up to receive commands from the user and set up to communicate one or more commands to the system, where the commands include indication of at least one unique position for the visual material;
where the camera is set up to give an adjustable magnification of the visual material which shall be displayed; and
a communication part to communicate instructions to a camera, said instructions comprise given position and wanted magnification for the visual material, and where the camera comprises a control part that controls the camera to provide an image of the chosen visual material at the given position with a chosen magnification.

2. System according to claim 1, where the control unit comprises a register encompassing a set of positions, and the user interface is set up to let the user choose one of the given positions.

3. System according to claim 2, where the camera is placed in the ceiling of a room encompassing at least two registered positions, of which the one position is the workplace of the user and the other is at one of the walls of the room.

4. System according to claim 1, where said commands include giving a wanted magnification of the visual material at a chosen position.

5. System according to claim 1, where said camera communicates wirelessly with said communication part.

6. System according to claim 1, comprising means for conversion of at least parts of the visual material into text symbols.

7. System according to claim 1, where said user interface comprises a keyboard where given commands are associated to keys chosen in advance.

8. System according to claim 1, where the commands comprise adjustments of chosen positions.

9. System according to claim 1, where the camera is a ceiling mounted camera fitted on a platform that can flip, where the camera also comprises a zoom objective to adjust the magnification of the visual material in the chosen position.

10. System according to claim 9, where the computer and camera are placed in a classroom, where at least one position is a workplace for a student and a second position is the place of the lecturer.

11. System according to claim 9, where the camera covers a radius of 360 degrees along a horizontal axis and up to 180 degrees along a vertical axis, where the camera also comprises a zoom objective to adjust the magnification of the visual material in the chosen position.

12. System according to claim 1, comprising means for the transmission of image signals directly from a projector to the screen of the computer, where the control unit is set up to execute commands on the image signals.

13. System according to claim 1, comprising tools for the processing of images received from the camera.
